(19) United States
(12) Patent Application Publication
(10) Pub. No.: US 2006/0291883 A1
(43) Pub. Date: Dec. 28, 2006

(54) Image formation apparatus and controlling method of fixing roller

(75) Inventor: Seok-heon Chae, Hwaseong-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/376,184

(22) Filed: Mar. 16, 2006

(30) Foreign Application Priority Data
Jun. 22, 2005 (KR) 2005-54028

(51) Int. Cl. G03G 15/20

(52) U.S. Cl. 399/69

(57) ABSTRACT

An image formation apparatus and a method of controlling a fixing unit thereof. The image formation apparatus includes: a fixing unit of applying a heat for fixing a toner on a sheet, and having a heating element mounted at one side of the fixing unit; a switch of controlling supplying a power to the heating element; a thermistor of sensing a temperature of the fixing unit; a sheet sensor of sensing whether the sheet passes through the fixing unit; a duty ratio calculation unit of calculating an on and off ratio of the switch; and a controller of controlling turning on and off the switch with a predetermined duty ratio calculated by the duty ratio calculation unit in response to whether the temperature of the fixing unit sensed by the thermistor has reached a preset target temperature and whether the sheet sensed by the sheet sensor is present. Accordingly, the temperature applied to one sheet or between sheets by the fixing roller can be uniformly maintained, so that the toner can be uniformly fixed during the printing, which can thus lead to an enhancement of a printed quality.

### CROSS-REFERENCE TO RELATED APPLICATIONS

This application claims the benefit of Korean Application No. 2005-54028, filed Jun. 22, 2005, in the Korean Intellectual Property Office, the disclosure of which is incorporated herein by reference.

### BACKGROUND OF THE INVENTION

1. Field of the Invention

An aspect of the present invention relates to an image formation apparatus and a method of controlling a temperature of a fixing unit thereof, and, in particular, to an image formation apparatus and a method of controlling a temperature of a fixing unit thereof which are capable of maintaining a uniform temperature by controlling a temperature of a fixing roller in response to presence/absence of a sheet in the fixing roller.

2. Description of the Related Art

In general, fixing units to fix toner transferred onto a sheet are installed in image formation apparatuses, such as laser beam printers or copy machines.

The conventional fixing unit must maintain a constant temperature to fix the toner, and, to this end, the image formation apparatus, as shown in FIG. 1, includes a power supply unit 20 supplying an AC power to the fixing unit 30, a heating element 35 disposed in the fixing unit 30 to generate heat, a thermistor 40 sensing a temperature of the heating element 35, a switch 25 turning on and off the AC power supplied from the power supply unit 20 to the heating element 35, and a controller 10 controlling the turning on and off of the switch 25 in response to the temperature of the heating element 35 sensed by the thermistor 40.

Such a fixing unit 30 has target temperatures which are set differently from each other in response to a warming up state, a standby state, and a printing state, respectively, and the controller 10 controls the turning on and off of the switch 25 so as to make a temperature of the heating element 35 maintain the target temperature when the temperature of the heating element 35 is different from the preset target temperature.

In general, a method of controlling the temperature of the fixing unit 30 via a use of the controller 10 is as follows. The controller first determines in which state the image formation apparatus is in from among the warming up state, the standby state, and the printing state, and sets a target temperature in response to the determined state. Where the image forming apparatus is in the printing state, the controller 10 sets the target temperature of the printing state and turns the switch 25 on to cause the heating element 35 to generate heat until the corresponding target temperature is reached. When the target temperature is reached, the controller 10 turns the switch 25 on and off as is necessary to maintain the target temperature, and, if the temperature of the fixing unit 30 falls below the preset temperature, the controller turns the switch 25 on again such that the AC power is supplied for the generating of heat.

Accordingly, as shown in FIG. 2A, the temperature of the fixing unit 30 changes while forming a ripple within a predetermined range centered on the target temperature. However, when the temperature information sensed by the thermistor 40 is sent to the controller 10, a predetermined delay time occurs until the thermistor senses the temperature of the heating element 35 in accordance with a response speed characteristic of the thermistor 40, which ranges from several seconds to hundreds of milliseconds. Accordingly, the temperature of the heating element 35 as recognized by the thermistor 40 varies from the actual temperature of the fixing unit 30 by a difference of the amount of the increase or decrease in temperature during the recognized delay time as shown in FIG. 2B.

In the meantime, a period where the AC power is supplied to the heating element 35 in response to the turning on and off of the switch 25, as shown in FIG. 2C, mimics the period of the temperature recognized by the thermistor 40 shown in FIG. 2B. Accordingly, at point A of FIG. 2A, an actual temperature of the fixing unit 30 is lower than the target temperature but the recognized temperature, shown in FIG. 2B, is at the target temperature, and at point B of FIG. 2A, the actual temperature of the fixing unit 30 is higher than the target temperature while the recognized temperature, shown in FIG. 2B is again at the target temperature. As a result, the switch 25 is turned on during the A to B interval to cause the heating element 35 to generate heat even when the temperature of the fixing unit 30 increases above the target temperature, so that an overshoot phenomenon occurs where the actual temperature increases excessively while changing from a lower state to a higher state than the target temperature. In contrast, the switch 25 is turned off when the temperature of the fixing unit 30 decreases during the B to C interval, so that an undershoot phenomenon occurs where the temperature decreases excessively while changing from a higher state to a lower state than the target temperature.

Repetition of such actions leads to a ripple effect (see FIGS. 2A and 2B) during the printing, and, in particular, a rate of temperature increase increases where the fixing unit 30 has a high capacity. Here, the overshoot or the undershoot phenomenon becomes severe. Accordingly, maintenance of a constant fixing temperature between sheets during the printing is difficult, and uniform maintenance of the fixing temperature even when one sheet is being printed is also difficult.

### SUMMARY OF THE INVENTION

It is therefore an aspect of the present invention to provide an image formation apparatus and a method of controlling the fixing unit thereof which are capable of uniformly maintaining the temperature of the fixing unit.

According to one aspect of the present invention, there is provided an image formation apparatus, which includes: a fixing unit, to apply a heat to fix toner on a sheet, having a heating element mounted at one side thereof; a switch to control a supplying of power to the heating element; a thermistor to sense a temperature of the fixing unit; a sheet sensor to sense a position of the sheet relative to the fixing unit; a duty ratio calculation unit to calculate a duty ratio of the switch; and a controller to control a turning on and off of the switch with the calculated duty ratio in response to the sensed temperature of the fixing unit relative to a preset target temperature and the sensed position of the sheet.

When the temperature of the fixing unit is found to be higher than the preset target temperature and the sheet is found to have passed through the fixing unit, the duty ratio calculation unit calculates the duty ratio to be lower than a duty ratio where the temperature of the fixing unit is found to be lower than the preset target temperature, and the controller turns the switch on with the duty ratio calculated by the duty ratio calculation unit.

When the temperature of the fixing unit is found to be higher than the preset target temperature and the sheet is found to have not passed through the fixing unit a, the controller may turn off the switch.

The sheet sensor may be an eject sensor which is disposed adjacent to the fixing unit and senses whether the sheet is discharged from the fixing unit, or may be a feed sensor which is disposed at any one side on a movement path of the sheet and senses the movement of the sheet.

According to another aspect of the present invention, there is provided an image formation apparatus, which includes: a fixing unit, to apply a heat to fix toner on a sheet, having a heating element mounted at one side thereof; a switch to control a supplying of power to the heating element; a thermistor to sense a temperature of the fixing unit; a sheet sensor to sense a type of the sheet; a duty ratio calculation unit to calculate a duty ratio of the switch; and a controller to control a turning on and off of the switch with the calculated duty ratio in response to whether the temperature of the fixing unit has reached a preset target temperature and based on the type of the sheet.

According to yet another aspect of the present invention, there is provided a method of controlling a temperature of a fixing unit of an image formation apparatus including the fixing unit to apply heat to fix toner on a sheet, the fixing unit having a heating element mounted at one side of the fixing unit, and the method including: sensing the temperature of the fixing unit; sensing whether the sheet passes through the fixing unit; calculating a duty ratio in response to whether the temperature of the fixing unit has reached a preset target temperature and whether the sheet is present; and controlling a supplying of power to the heating element with the calculated predetermined duty ratio.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a schematic structure block view illustrating an image formation apparatus of the related art;

FIG. 2A is a graph illustrating temperature changes of the conventional fixing unit;

FIG. 2B is a graph illustrating temperature changes of the conventional fixing unit sensed by a thermistor;

FIG. 2C is a graph illustrating states of a switch that turns the supplying of an AC power on and off to the fixing unit;

FIG. 3 is a schematic structure block view illustrating an image formation apparatus in accordance with an embodiment of the present invention; and

FIG. 4 is a flow chart illustrating a procedure of controlling a temperature of the fixing unit in the image formation apparatus in accordance with an embodiment of the present invention.

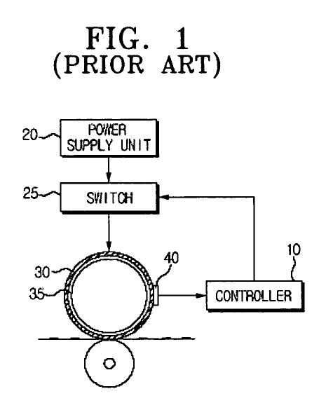

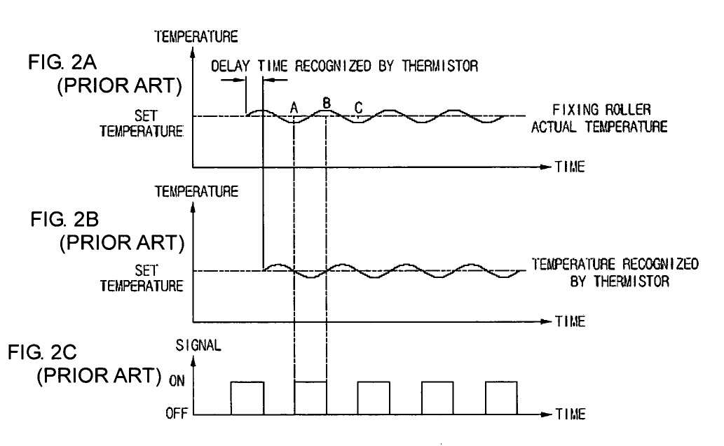

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

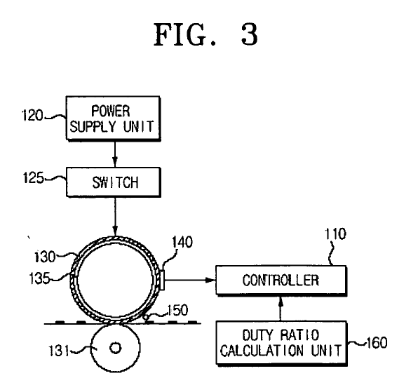

FIG. 3 is a schematic structure block view illustrating an image formation apparatus in accordance with an embodiment of the present invention. As shown in FIG. 3, the present image formation apparatus includes a fixing unit, including a fixing roller 130 and a pressing roller 131, a power supply unit 120, a heating element 135, a switch 125, a thermistor 140, a sheet sensor 150, a duty ratio calculation unit 160, and a controller 110.

The fixing unit, including the fixing roller 130 and the pressing roller 131, is a device to fix toner transferred onto a sheet to the sheet, and includes the fixing roller 130 and the pressing roller 131 which face each other with the sheet being interposed therebetween. According to this embodiment of the invention, the heating element 135 is mounted on an inner side of the fixing roller 130. The power supply unit 120 supplies an AC power to the heating element 135 mounted on the inner side of the fixing roller 130, and the switch 125 is turned on and off by the controller 110, so that the switch 125 supplies or blocks the AC power delivered from the power supply unit 120 to the heating element 135. The thermistor 140 to sense a temperature of the fixing roller 130 is mounted on one side of the fixing unit, including the fixing roller 130 and the pressing roller 131. The temperature information of the fixing roller 130, sensed by the thermistor 140, is delivered to the controller 110 and is used as a reference of when to turn the switch 125 on and off.

At least one sheet sensor 150 to sense a presence of the sheet of paper is mounted on a side of the image formation apparatus. According to embodiments of the invention, the sheet sensor 150 comprises a feed sensor mounted adjacent to a photosensitive drum (not shown), and an eject sensor mounted adjacent to the fixing roller 130. The feed sensor senses whether the sheet has passed the photosensitive drum, and the eject sensor senses whether the sheet has passed the fixing roller 130. Sensed results of the feed sensor and the eject sensor are delivered to the controller 110. The controller 110 then determines when the sheet has passed the fixing roller 130 in response to the sensed results of the respective sensors. For example, when information that the sheet is sensed by the feed sensor is delivered to the controller 110, the controller 110 calculates when the sheet reaches the fixing roller 130 in consideration of a distance between the feed sensor and the fixing roller 130 and a printing speed.

The duty ratio calculation unit 160 calculates the duty ratio as an on-time period of the switch 125 in response to a determination of whether the sheet is disposed at the fixing roller 130 and in response to a temperature of the fixing roller 130 sensed by the thermistor 140. The duty ratio calculation unit 160 adjusts the duty ratio to cause the temperature of the fixing roller to reach a preset target temperature relatively quickly when the temperature of the fixing roller 130 sensed by the thermistor 140 is lower or higher than the preset target temperature, and in response to whether the sheet is sensed to be passing the fixing roller 130 when the temperature of the fixing roller 130, sensed by the thermistor 140, reaches the preset target temperature. In more detail, the duty ratio calculation unit 160 decreases the duty ratio when the temperature of the fixing roller 130 has reached the target temperature but the sheet is passing the fixing roller 130. Thus, the fixing roller 130 is made to maintain the target temperature for a predetermined time. Such a duty ratio is calculated differently in response to a capacity of the image formation apparatus, so that the present invention is not limited to the specific value thereof.

The controller 110 controls operations of respective components constituting the image formation apparatus, and sets separate target temperatures of the fixing roller 103 in response to respective operational states of the image formation apparatus. These respective operational states are a presence/absence of a warming up state, a standby state, and a printing state

As discussed hereinabove, the controller 110 determines the temperature of the fixing roller 130 via the thermistor 140 and based on whether the sheet is passing through the fixing roller 130. The controller 110 turns the switch 125 on to cause the AC power to be supplied to the heating element 135 when the temperature of the fixing roller 130, sensed by the thermistor 140, is sensed to be lower than a preset target temperature, and activates the duty ratio calculation unit 160 to increase the duty ratio when the target temperature needs to increase relatively quickly. In greater detail, when the temperature of the fixing roller 130 sensed by the thermistor 140 is higher than the preset target temperature, and a sensed result of the sheet sensor 150 is that the sheet is disposed at the fixing roller, the controller 110 turns the switch 125 off and operates the duty ratio calculation unit 160 so as to decrease the duty ratio. Similarly, when the temperature of the fixing roller 130 sensed by the thermistor 140 is higher than the preset target temperature, and a sensed result of the sheet sensor 150 is that the sheet is not disposed at the fixing roller, the controller 110 turns the switch 125 off.

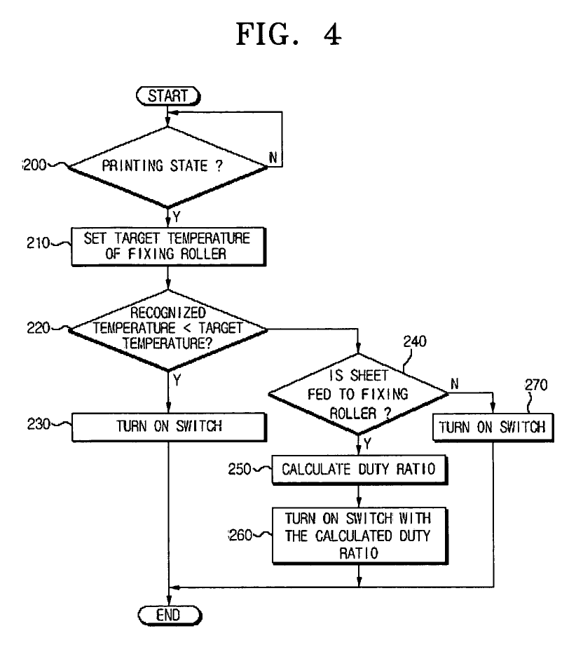

Hereinafter, a procedure of controlling the temperature of the fixing unit, including the fixing roller 130 and the pressing roller 131, in the image formation apparatus having the above-described structure will be described with reference to FIG. 4.

The controller 110 first determines whether the image formation apparatus is in a printing state (200), and, where the controller 110 finds that the image formation apparatus is in an initial printing state, the controller 110 sets the target temperature of the fixing roller 130 accordingly (210). The thermistor 140 senses the temperature of the fixing roller 130 and delivers the recognition information about the sensed temperature to the controller 110, and the sheet sensor 150 senses whether the sheet is fed or discharged and delivers the sensed result to the controller 110. Here, the sheet sensor 150 may comprise a feed sensor and an eject sensor, or may comprise an additional sensor between the feed sensor and the eject sensor.

The controller 110 determines whether the recognized temperature delivered from the thermistor 140 is lower than the preset target temperature of the fixing roller 130 (220), and, if the controller 110 finds that the recognized temperature is lower than the preset target temperature of the fixing roller 130, turns the switch 125 on to cause the AC power to be supplied to the heating element 135 (230). Here, the controller 110 activates the duty ratio calculation unit 160 to adjust the duty ratio when the duty ratio needs to be changed in response to predetermined conditions such as a difference between the recognized temperature and the target temperature, a printing speed, and so forth.

In the meantime, when the recognized temperature is found to be higher than the target temperature, the controller 110 determines whether the sheet is currently passing through the fixing roller 130 or whether the sheet remains to be fed via the sheet recognition information delivered from the sheet sensor 150 (240). When the sheet is currently passing through the fixing roller 130 or is to be supplied, the controller 110 activates the duty ratio calculation unit 160 to adjust the duty ratio (250), and turns the switch 125 on and off in accordance with the calculated duty ratio (260). Here, the switch 125 is turned on even when the recognized temperature is higher than the target temperature, because the temperature of the fixing roller 130 decreases when the sheet has passed through the fixing roller. However, when the AC power is supplied to the heating element 135 with the duty ratio applied in a case that the recognized temperature is lower than the target temperature, the temperature of the fixing roller 130 may increase relatively excessively. Thus, adjusting the duty ratio to be small may be necessary.

Alternatively, when the recognized temperature is higher than the target temperature and the sheet is found to have not passed through the sheet sensor 150, the controller 110 turns the switch 125 off to decrease the temperature of the fixing roller 130 (270).

As such, in accordance with the image formation apparatus according to an aspect of the present invention, AC power is made to be supplied to the heating element 135 by adjusting the duty ratio when printing is being carried out in the fixing roller 130 even when the temperature of the fixing roller 130 recognized by the thermistor 140 is higher than the preset target temperature. Accordingly, by causing the fixing roller 130 to uniformly maintain the target temperature during the printing, the temperature applied to one sheet or between sheets by the fixing roller 130 may be uniformly maintained. Therefore, toner may be uniformly fixed during the printing, which leads to an enhancement of print quality. Such an effect may be more remarkable where the fixing unit, including the fixing roller 130 and the pressing roller 131, has a fast printing speed and a large capacity. In addition, the temperature of the fixing roller 130 may be more finely adjusted, so that an effect of the recognized delay time of the thermistor 140 may be minimized.

In the meantime, in accordance with the above-described embodiment, when the recognized temperature sensed by the thermistor 140 is higher than the target temperature, whether the sheet has passed the fixing roller 130 is determined by the sheet sensor 150 and the duty ratio of the switch 125 is made to decrease or the switch 125 is turned off in response to the determination.

According to an embodiment of the invention, the duty ratio or the turning on and off of the switch 125 may be controlled in response to a size of the sheet in addition to other factors, such as the presence/absence of the sheet as sensed by the sheet sensor 150. For example, in a case of thick sheet such as a card, an envelope, or a sheet containing cotton, the duty ratio is made to decrease slightly so as to allow the power to be supplied in accordance with the width of the sheet. Where the sheet is an A4 sheet, the duty ratio is made to sufficiently decrease so as to allow the power to be supplied, and in a case of a thin sheet or a sheet having a specific material quality which is sensitive to heat such as an OHP film, the switch 125 may be turned off. As such, the switch 125 is turned on in a case where the sheet consumes large heat capacities when the sheet is mounted, and the switch 125 is turned off in a case where the sheet consumes small heat capacities, so that the temperature of the fixing unit, including the fixing roller 130 and the pressing roller 131 may be maintained at the target temperature.

According to aspects of the present invention as described above, the temperature applied to one sheet or between sheets by the fixing roller may be uniformly maintained, so that the toner is uniformly fixed during printing. Thus, an enhancement of print quality is brought about.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An image formation apparatus, comprising:
a fixing unit, to apply a heat to fix toner on a sheet, having a heating element mounted at one side thereof;
a switch to control a supplying of power to the heating element;
a thermistor to sense a temperature of the fixing unit;
a sheet sensor to sense a position of the sheet relative to the fixing unit;
a duty ratio calculation unit to calculate a duty ratio of the switch; and
a controller to control a turning on and off of the switch with the calculated duty ratio in response to the sensed temperature of the fixing unit relative to a preset target temperature and the sensed position of the sheet.

2. The image formation apparatus according to claim 1, wherein, when the temperature of the fixing unit is found to be higher than the preset target temperature and the sheet is found to have passed through the fixing unit, the duty ratio calculation unit calculates the duty ratio to be lower than a duty ratio where the temperature of the fixing unit is found to be lower than the preset target temperature, and the controller turns the switch on with the calculated duty ratio.

3. The image formation apparatus according to claim 2, wherein, when the temperature of the fixing unit is found to be higher than the preset target temperature and the sheet is sensed as not having passed the fixing unit, the controller turns the switch off.

4. The image formation apparatus according to claim 3, wherein the sheet sensor comprises an eject sensor, which is adjacent to the fixing unit and which senses whether the sheet is discharged from the fixing unit.

5. The image formation apparatus according to claim 3, wherein the sheet sensor comprises a feed sensor, which is disposed at any one side on a movement path of the sheet and which senses the movement of the sheet.

6. An image formation apparatus, comprising:
a fixing unit, to apply a heat to fix toner on a sheet, having a heating element mounted at one side thereof;
a switch to control a supplying of power to the heating element;
a thermistor to sense a temperature of the fixing unit;
a sheet sensor to sense a type of the sheet;
a duty ratio calculation unit to calculate a duty ratio of the switch; and
a controller to control a turning on and off of the switch with the calculated duty ratio in response to whether the temperature of the fixing unit has reached a preset target temperature and based on the type of the sheet.

7. The image formation apparatus according to claim 6, wherein, when the temperature of the fixing unit is found to be higher than the preset target temperature and a thickness of the sheet is found to be larger than a predetermined thickness, the duty ratio calculation unit calculates the duty ratio to be lower than a duty ratio where the temperature of the fixing unit is found to be lower than the preset target temperature, and the controller turns the switch on with the duty ratio to cause the power to be supplied to the heating element.

8. A method of controlling a temperature of a fixing unit of an image formation apparatus that applies a heat to fix toner on a sheet, the fixing unit having a heating element mounted at one side thereof, the method comprising:
sensing the temperature of the fixing unit;
sensing whether the sheet has passed through the fixing unit;
calculating a duty ratio in response to whether the temperature of the fixing unit is found to have reached a preset target temperature and whether the sheet is found to have passed through the fixing unit; and
controlling a supplying of power to the heating element with the calculated predetermined duty ratio.

9. The method according to claim 8, wherein the calculating of the duty ratio comprises, when the temperature of the fixing unit is found to be higher than the preset target temperature and the sheet is found to have passed through the fixing unit, calculating the duty ratio to be lower than a duty ratio where the temperature of the fixing unit is found to be lower than the preset target temperature.

10. The method according to claim 9, wherein the controlling of the supplying of the power comprises, when the temperature of the fixing unit is found to be higher than the preset target temperature and the sheet is found to have passed through the fixing unit, supplying the power to the fixing unit with the calculated low duty ratio.

11. The method according to claim 8, wherein the controlling of the supplying of the power comprises, when the temperature of the fixing unit is found to be higher than the preset target temperature and the sheet is found to have not passed through the fixing unit, blocking the power supplied to the fixing unit.

12. A method of controlling a temperature of a fixing unit of an image formation apparatus that applies a heat to fix toner on a sheet, the fixing unit having a heating element mounted at one side thereof, the method comprising:
sensing the temperature of the fixing unit;
sensing a type of the sheet passing through the fixing unit;
calculating a duty ratio in response to whether the temperature of the fixing unit is found to have reached a preset target temperature and/or based on a type of the sheet; and
controlling a supplying of power to the heating element with the calculated predetermined duty ratio.

13. The method according to claim 12, wherein the sensing of the type of the sheet comprises sensing at least one of a thickness and a material of the sheet.

14. The method according to claim 12, wherein the calculating of the duty ratio comprises, when the temperature of the fixing unit is found to be higher than the preset target temperature and the sheet is found to have a thickness larger than a predetermined thickness, calculating the duty ratio to be lower than a duty ratio where the temperature of the fixing unit is found to be lower than the preset target temperature.

15. An image formation apparatus, in which a fixing unit applies heat to fix toner on a sheet from a heating element, the apparatus comprising:
a switch to control a supply of power to the heating element;
a sensing unit to sense a temperature of the fixing unit and to sense at least one of a position of the sheet relative to the fixing unit and/or a type of the sheet;
a duty ratio calculation unit to calculate a duty ratio of the switch; and
a controller to control a turning on and off of the switch with the calculated duty ratio in response to the sensed temperature of the fixing unit relative to a preset target temperature and the at least one of the sensed position of the sheet and/or the sensed type of the sheet.

16. A method of controlling a temperature of a fixing unit of an image formation apparatus that applies a heat to fix toner on a sheet, the fixing unit having a heating element mounted at one side thereof, the method comprising:
sensing the temperature of the fixing unit;
sensing whether the sheet passes through the fixing unit and a type of the sheet;
calculating a duty ratio in response to whether the temperature of the fixing unit is found to have reached a preset target temperature and based on at least one of whether the sheet is found to have passed through the fixing unit and/or the type of the sheet; and
controlling a supplying of power to the heating element with the calculated predetermined duty ratio.

17. The method according to claim 16, wherein the calculating comprises decreasing the duty ratio from an initial ratio thereof when the temperature of the fixing unit has reached the preset target temperature and the sheet is found to be passing through the fixing roller.

18. The method according to claim 17, wherein the switch is turned off when the type of sheet is found to be a type that is relatively sensitive to heat.
